(19) United States
(12) Patent Application Publication
(10) Pub. No.: US 2024/0412218 A1
(43) Pub. Date: Dec. 12, 2024

(54) ENHANCED FINANCIAL ACCOUNT MANAGEMENT AND TRANSACTION CAPABILITIES

(71) Applicant: American Express Travel Related Services Company, Inc., New York, NY (US)

(72) Inventors: Rajendra Prasad Modadugu, Weston, FL (US); Jyothsna Nayak, Weston, FL (US)

(21) Appl. No.: 18/206,177

(22) Filed: Jun. 6, 2023

(51) Int. Cl. G06Q 20/40; G06Q 20/10

(52) U.S. Cl. CPC G06Q 20/4016; G06Q 20/102

(57) ABSTRACT

Disclosed are various embodiments for enhancing financial capabilities of transaction accounts. A user could request a modified purchasing power or request to split a transaction between a plurality of transaction accounts. First, the global purchasing capacity is calculated. Next, the risk exposure is calculated based at least in part on a risk profile and the global purchasing capacity. Next, a respective purchasing power of a transaction account is modified. The modification of the respective purchasing power could cause the global purchasing capacity to be recalculated. Next, the user is notified of the modified purchasing power. In some instances, the purchasing power could be modified by splitting the transaction between the plurality of transaction accounts or between a first transaction account and a second transaction account.

### BACKGROUND

Financial institutions offer a variety of transaction accounts (e.g., credit card accounts, charge card accounts, debit card accounts, checking accounts, money market accounts, or other demand deposit, stored value, credit accounts, etc.) to their users. Typically, each transaction account has a purchasing power or a limit. When a user has multiple transaction accounts with the financial institution, each transaction account is treated as a separate transaction account. As a result, a user's ability to make a purchase is limited by the purchasing power of an individual transaction account.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a user interface diagram according to various embodiments of the present disclosure.

FIG. 1B is a user interface diagram according to various embodiments of the present disclosure.

FIG. 1C is a user interface diagram according to various embodiments of the present disclosure.

FIG. 1D is a user interface diagram according to various embodiments of the present disclosure.

FIG. 1E is a user interface diagram according to various embodiments of the present disclosure.

FIG. 2A is a user interface diagram according to various embodiments of the present disclosure.

FIG. 2B is a user interface diagram according to various embodiments of the present disclosure.

FIG. 2C is a user interface diagram according to various embodiments of the present disclosure.

FIG. 2D is a user interface diagram according to various embodiments of the present disclosure.

FIG. 2E is a user interface diagram according to various embodiments of the present disclosure.

FIG. 2F is a user interface diagram according to various embodiments of the present disclosure.

FIG. 3 is a user interface diagram according to various embodiments of the present disclosure.

FIG. 4 is a drawing of a network environment according to various embodiments of the present disclosure.

FIG. 5A is a flowchart illustrating one example of functionality implemented as portions of an application executed in a computing environment in the network environment of FIG. 4 according to various embodiments of the present disclosure.

FIG. 5B is a flowchart illustrating one example of functionality implemented as portions of an application executed in a computing environment in the network environment of FIG. 4 according to various embodiments of the present disclosure.

FIG. 6A is a flowchart illustrating one example of functionality implemented as portions of an application executed in a computing environment in the network environment of FIG. 4 according to various embodiments of the present disclosure.

FIG. 6B is a flowchart illustrating one example of functionality implemented as portions of an application executed in a computing environment in the network environment of FIG. 4 according to various embodiments of the present disclosure.

FIG. 7A is a flowchart illustrating one example of functionality implemented as portions of an application executed in a computing environment in the network environment of FIG. 4 according to various embodiments of the present disclosure.

FIG. 7B is a flowchart illustrating one example of functionality implemented as portions of an application executed in a computing environment in the network environment of FIG. 4 according to various embodiments of the present disclosure.

FIG. 8 is a flowchart illustrating one example of functionality implemented as portions of an application executed in a computing environment in the network environment of FIG. 4 according to various embodiments of the present disclosure.

FIG. 9 is a flowchart illustrating one example of functionality implemented as portions of an application executed in a computing environment in the network environment of FIG. 4 according to various embodiments of the present disclosure.

### DETAILED DESCRIPTION

Disclosed are various approaches for enhancing financial transaction capabilities for transaction accounts. In some embodiments, the user can split the posted transactions between transaction accounts. In some other embodiments, the user can request an increased purchasing power for a transaction account.

Typically, financial institutions offer a variety of transaction accounts (e.g., credit card accounts, charge card accounts, debit card accounts, checking accounts, money market accounts, or other demand deposit, stored value, credit accounts, etc.) to their users. In some instances, a user may have a first transaction account with a lower purchasing power than a second transaction account with a higher purchasing power. This can lead to situations where a user lacks sufficient purchasing power on for any one transaction account to make a purchase, even if the user has sufficient purchasing power when the transaction accounts of the user are viewed in the aggregate. In other instances, the user may desire to have a higher purchasing power for the first transaction account to make a purchase or maximize a service/benefit offered by the first transaction account that is not offered by the second transaction account.

Previously, a user might have addressed these problems using various approaches. For example, the user could apply for a new transaction account with a greater purchasing power (e.g., a higher credit limit). As another example, a user could apply for or request an increased purchasing power (e.g., an increased credit limit). Alternatively, a user could make transfer funds to the transaction account in order to increase the available purchasing power (e.g., paydown the outstanding credit card balance or make a deposit to checking account).

In contrast, the approaches herein introduce enhanced capabilities for financial transactions and transaction accounts. For example, embodiments of the present disclosure allow a user to request to split a posted transaction with a plurality of transaction accounts the user has with the financial institution. An illustrative and non-limiting example can include a user having multiple transaction accounts at a financial institution, wherein transaction account A has a purchasing power of $10,000 and transaction account B has a purchasing power of $15,000. In this illustrative and non-limiting example, a user has completed a purchase for $9,500 at a business warehouse using account A, but also has to make another purchase of $5,000 using account A. The user can split (e.g., by percentage, specific amount, etc.) the $9,500 transaction between transaction account A and transaction account B. For example, the user can split the transaction by allocating $4,500 of the $9,500 transaction to transaction account B to complete the $5,000 purchase on transaction account A.

In another example, embodiments of the present disclosure allow the user to request the purchasing power of the transaction account to be increased based at least in part on the global purchasing capacity, wherein the global purchasing capacity is the total purchasing power of all the transaction accounts belonging to the user at the financial institution. An illustrative and non-limiting example can include the user having three transaction accounts at a financial institution, wherein transaction account A has a purchasing power of $10,000, transaction account B has a purchasing power of $15,000, and transaction account C has a purchasing power of $25,000. In this illustrative and non-limiting example, the global purchasing capacity of the user is $50,000, wherein the user can request a higher purchasing power on transaction account A based at least in part on the global purchasing capacity of $50,000.

In some other examples, embodiments of the present disclosure allow the user to request a respective purchasing power of the transaction account to be increased to split a transaction. In some instances, splitting the transaction from a first transaction account to a second transaction account can allow a user to maximize a service/benefit offered by the first transaction account that is not offered by the second transaction account. If the second transaction account does not have the purchasing power required based on the user specified split amount, the user can request a modification to the purchasing power of the second account. After modification of the purchasing power, the user can split the transaction from the first transaction account to the second transaction account.

Techniques described herein of enhanced financial account management and transaction capabilities provide a significant technical improvement by reducing database storage requirements (e.g., storing information for a new transaction account, storing information for the user, etc.), reducing network bandwidth requirements (e.g., related to evaluating and processing new transaction account applications), and improved data analysis and reporting (e.g., applying existing information for enhanced transaction account functionality). The techniques described herein of enhanced financial account management and transaction capabilities can also provide a significant technical benefit such as streamlining account management (e.g., using a single application, managing multiple transaction accounts using single credentials, etc.), optimized transaction account awards and benefits, and reduced operation costs (e.g., less equipment, fewer personnel, etc.).

In the following discussion, a general description of the system and its components is provided, followed by a discussion of the operation of the same.

Although the following discussion provides illustrative examples of the operation of various components of the present disclosure, the use of the following illustrative examples does not exclude other implementations that are consistent with the principals disclosed by the following illustrative examples.

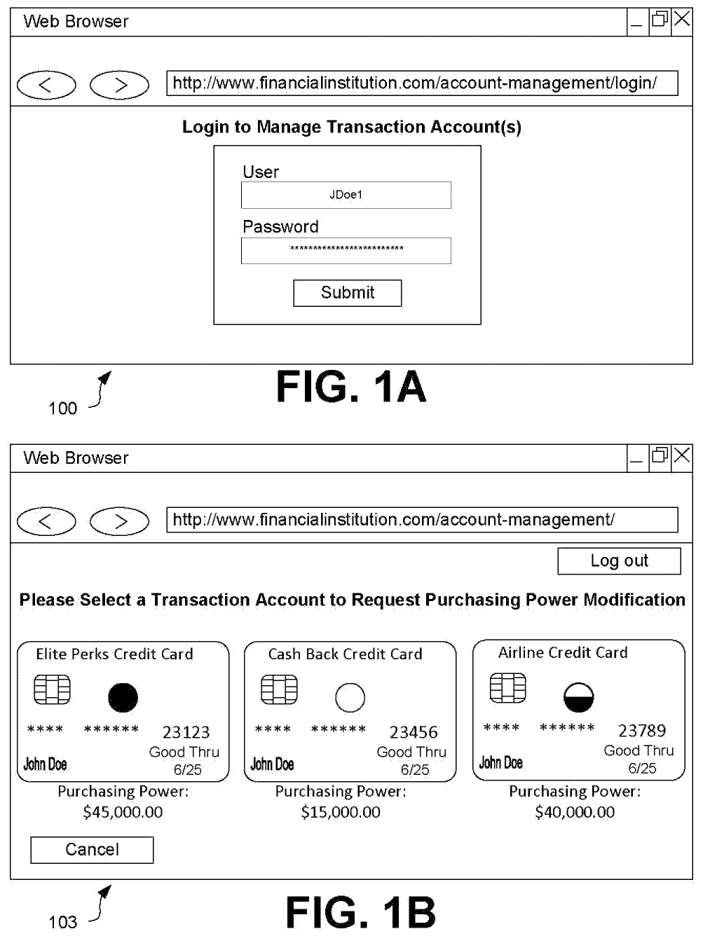

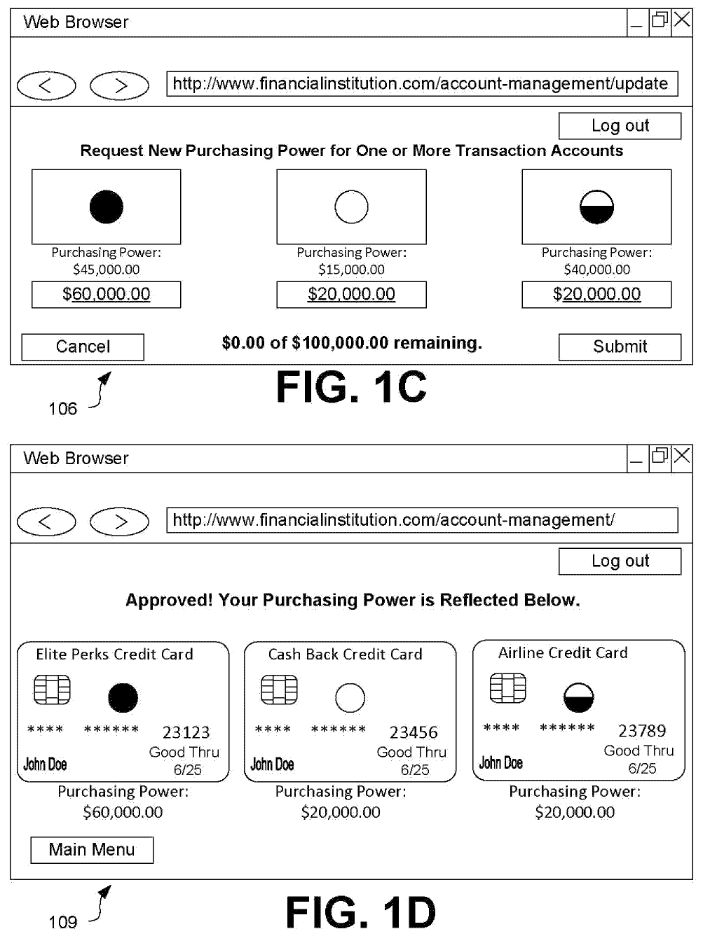

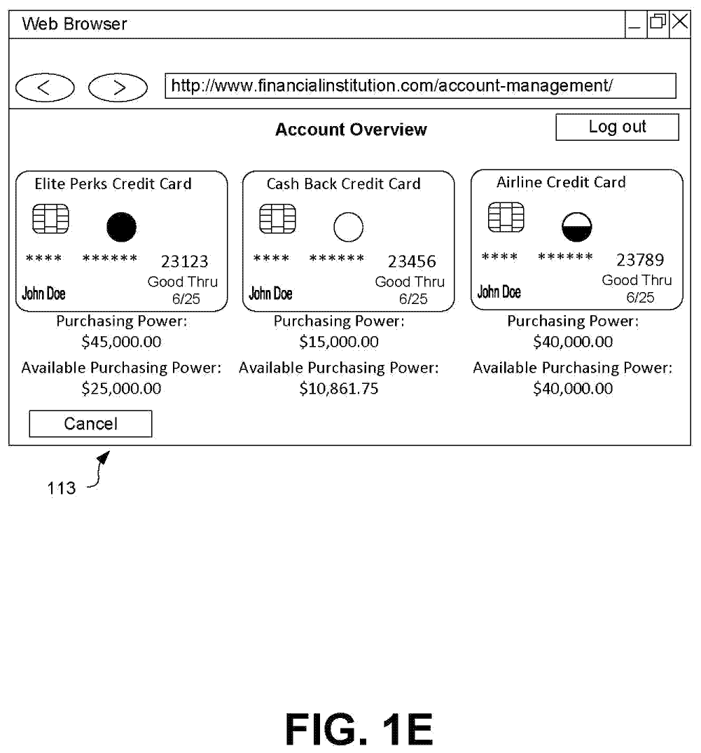

FIGS. 1A-1E depict various examples of scenarios where a user could begin a purchasing power modification process according to various embodiments of the present disclosure. In each of these examples, a user is able to login in to request the purchasing power modification for a transaction account associated with the user. For example, a user could request an increase in the purchasing power on a credit card based at least in part on a global purchasing capacity.

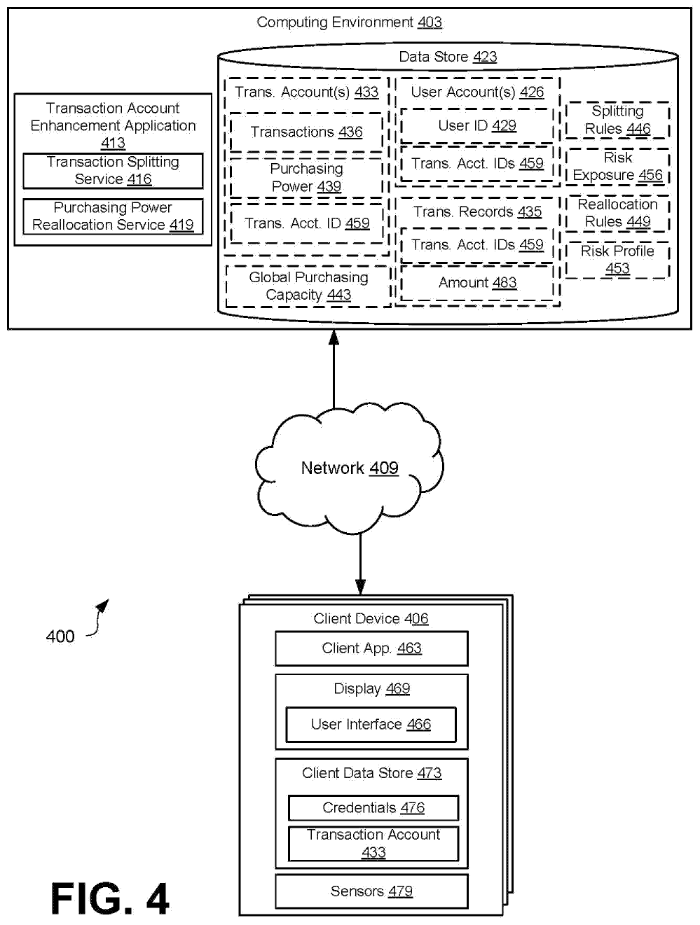

Referring to FIGS. 1A-1E, shown is a user interface diagram 100, 103, 106, and 109, displayed on a display 469 (FIG. 4) of the client device 406 (FIG. 4). In some instances, the user interface 466 (FIG. 4) can be rendered on the display 469 by a web browser. In other instances, the user interface 466 can be rendered and displayed on a dedicated application, a mobile application, or other related environments. The user interface 466 represents an application to request modification to the purchasing power 139 of the transaction account 433 (FIG. 4). The user interface 466 can be rendered by the client application 463 (FIG. 4).

With reference to FIG. 1A, the user interface diagram 100 provides affordances for the user to input credentials, (e.g., username and password, physical security key, etc.) to request modification to the purchasing power 139 of the transaction account 433. The user interface 466 of the client device 406 can be used to input the requested username and password. In some instances, an input device can be used to input the requested credentials. Once the credentials, the user can click the “Submit” button to submit the credentials for authentication. In some examples, the credentials can be based at least in part on a user account 426.

Referring next to FIG. 1B, in this example, the user provided credentials are authenticated to request modification to the purchasing power 439. The user can be presented with a list of transaction accounts 433 that are associated with the user account 426. In some examples, the transaction accounts 433 can be presented with an image of the transaction account 433. The user can select one of the transaction accounts 433 to request modification to the purchasing power 439. The transaction account 433 can be selected by clicking on the image of the transaction account 433. In some other examples, the transaction account 433 can be selected via a drop-down menu. In some other examples, the transaction account 433 could be selected from the list of transaction accounts 433. In this instance, the user interface 466 includes three transaction accounts 433 depicted by the image of the transaction account 433. In some examples, the user can request modification to the purchasing power 139 of a plurality of transaction accounts 433. In the instance of requesting modification to the plurality of transaction account 433, the transaction accounts can be selected via the drop-down menu or selecting from the list of transaction accounts 433. If the user does not want to proceed with the modification of the purchasing power 439, the user can cancel the request by clicking the “Cancel” button. In some examples, pressing the “Cancel” button can redirect the user to the main menu. In other examples, pressing the “Cancel” button can redirect the user to the previous page. The user can terminate the session by clicking the “log out” button. In some instances, clicking the “Log out” button will redirect the user to the user interface of FIG. 1A.

Referring next to FIG. 1C, the user requested modification to a respective purchasing power of the plurality of transaction accounts 433. The user interface 466 can display the transaction accounts 433 selected by the user with the respective purchasing power 439 of the transaction account 433. The user interface 466 also displays a global purchasing capacity 443 of the transaction accounts 433 associated with the user. In some examples, the global purchasing capacity 443 can include the total of the respective purchasing power 439 of the transaction accounts 433 associated with the user. The user interface 466 further includes an input box for the user to input a value for the modification of the purchasing power 439. In some examples, the user can only input a value that is less than or equal to the global purchasing capacity 443. The user can modify to the maximum of the global purchasing capacity 443 and the total can be reflected on the user interface 466. In this instance, the user has a global purchasing capacity 443 of $100,000. The input by the user can only equal $100,000. The user interface 466 can reflect the difference of the input and the global purchasing capacity 443 with a message or a notification. For example, if the total input was $40,000, the message or notification can display “$60,000 of $100,000 remaining.” In some examples, pressing the “Cancel” button can redirect the user to the main menu. In other examples, pressing the “Cancel” button can redirect the user to the previous page. The user can terminate the session by clicking the “log out” button. In some instances, clicking the “Log out” button can redirect the user to the user interface of FIG. 1A. The user can submit the request for modification of the purchasing power 139 by clicking the “submit” button.

Referring next to FIG. 1D, the user submitted the request to modify the purchasing power 439 of the plurality of transaction accounts 433. The user interface 466 can display the image of the respective transaction account 433 and the modified purchasing power 439. The user interface 466 can notify the user of a status of the request to modify the purchasing power 439. In other embodiments, the user interface 466 can display the list of the transaction accounts 433 and the modified purchasing power 439. In some examples, the respective purchasing power 439 can remain the same. In this example, the user can terminate the session by clicking the “Log out” button. The user can navigate to the main menu of the transaction account management user interface by clicking the “main menu” button.

Referring next to FIG. 1E, the user is redirected to the main menu after modification of the purchasing power 439 of the plurality of transaction accounts 433. The user interface 466 can display the image of the respective transaction account 433, the modified purchasing power 439, and the available purchasing power. The available purchasing power is the remaining balance available to the user after accounting for the transactions 436 that are current posted and pending on the transaction account 433. For example, if the user has a purchasing power of $45,000.00 on the “Elite Perks Credit Card,” and currently has $15,000.00 transaction that are either posted or pending, the available purchasing power is $25,000.00 for the “Elite Perks Credit Card.”

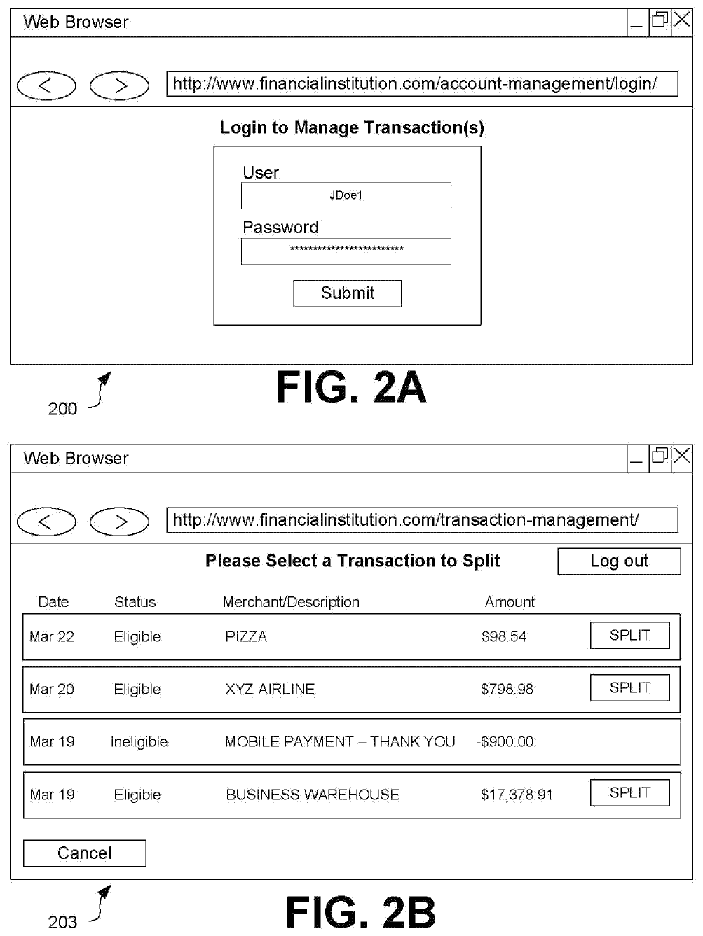

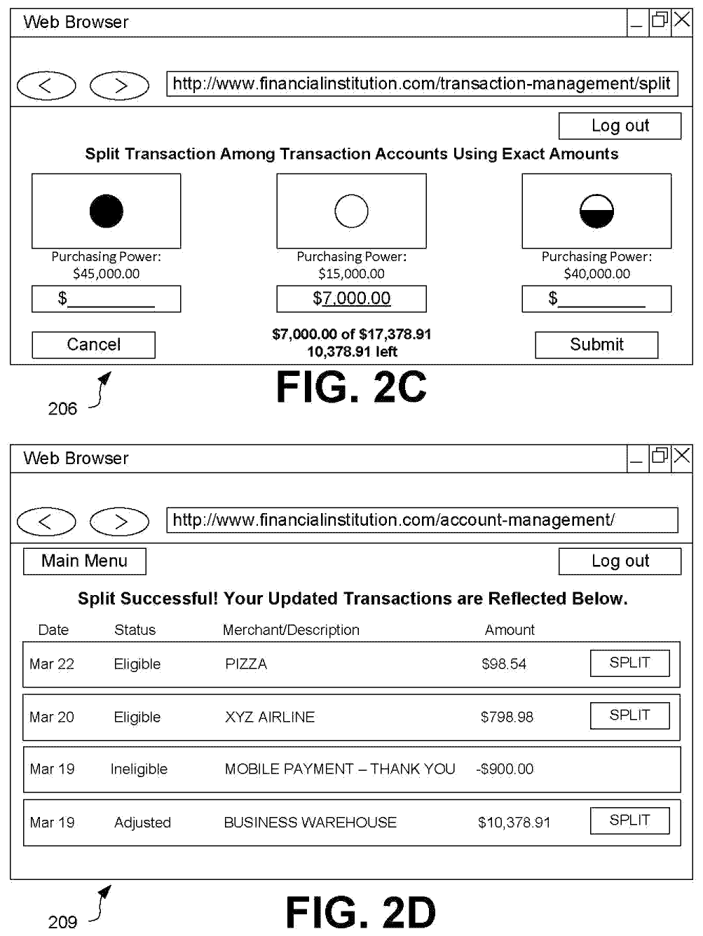

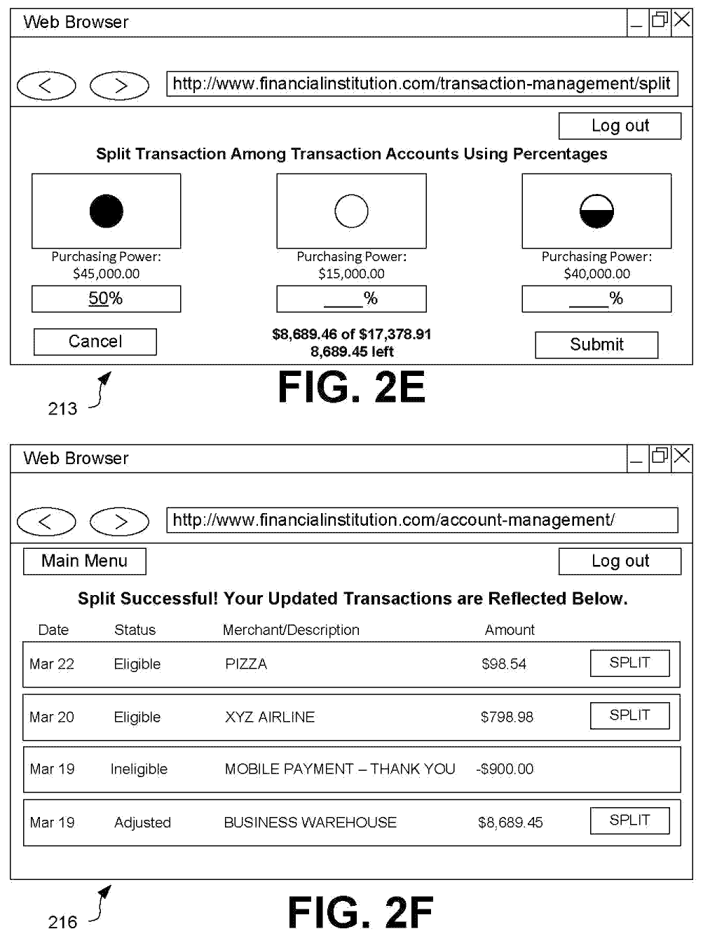

FIGS. 2A-2F depict various examples of scenarios where the user could begin a transaction split process according to various embodiments of the present disclosure. In each of these examples, a user is able to login in to request the transaction associated with a first transaction account to be split with one or more transaction accounts associated with the user. For example, a user could split a $10,000 transaction between three transaction accounts associated with the user.

Referring to FIGS. 2A-2F, shown is a user interface diagram 200, 203, 206, 209, 213, and 216, displayed on a display 469 (FIG. 4) of the client device 406 (FIG. 4). In some instances, the user interface 466 (FIG. 4) can be rendered on the display 469 by a web browser. In other instances, the user interface 466 can be rendered and displayed on a dedicated application, a mobile application, or other related environments. The user interface 466 represents an application to request modification to the purchasing power 439 (FIG. 4) of the transaction account 433 (FIG. 4). The user interface 466 can be rendered by the client application 463 (FIG. 4).

With reference to FIG. 2A, the user interface diagram 200 provides options for the user to input credentials (e.g., username and password, physical security key, etc.) and/or to request to split one or more transactions 436 (FIG. 4) associated with the transaction account 433. The user interface 466 of the client device 406 can be used to input the requested username and password. In some instances, an input device can be used to input the requested credentials. Once the credentials are provided by the user, the user can click the “Submit” button to submit the credentials for authentication. In some examples, the credentials can be based at least in part on the user account 426 (FIG. 4).

Referring next to FIG. 2B, the user was authenticated with the transaction account management user interface to request to split one or more eligible transactions 436. The user can select one of the transactions 436 to be split from a first transaction account to a second transaction account. In some embodiments, the transaction 436 could be unavailable to be split. In some examples, the transaction 436 can be split between a plurality of transaction accounts 433. The transaction 436 can be selected by clicking the transaction record 435 (FIG. 4). In some other examples, the transaction 436 can be selected via a drop-down menu. In some other examples, the transaction account 433 could be selected from a list of transactions 436 or transaction records 435. If the user does not want to proceed to split the transaction 436, the user can cancel the request by clicking the “Cancel” button. In some examples, pressing the “Cancel” button can redirect the user to the main menu. In other examples, pressing the “Cancel” button can redirect the user to the previous page. The user can terminate the session by clicking the “log out” button. In some instances, clicking the “Log out” button will redirect the user to the user interface of FIG. 2A.

Referring next to FIG. 2C, the user selected the eligible transaction to be split. The user interface 466 can display one or more of the transaction accounts 433 assigned to the user. In some examples, the user can split the transaction 436 between the plurality of transaction accounts 433 assigned to the user. In some embodiments, the user interface 466 can include the global purchasing capacity 443 (FIG. 4) of the user. In some examples, the global purchasing capacity 443 can be calculated to include the respective purchasing power 439 (FIG. 4) of the transaction accounts 433 associated with the user. The user interface 466 further includes an input box for the user to input the specific amount for splitting the transaction 436. In some examples, the number input by the user can be limited to the amount 483 of the transaction 436. The amount 483 (FIG. 4) of the transaction 436 can be reflected on the user interface 466. For example, if the user selected the “business warehouse” transaction with the amount 483 of “$10,378.91,” the user interface 466 can reflect the specific amount split with a message such as “$7,000.00 of $17,378.91.” In some embodiments, the user interface 466 can display the amount 483 of the transaction 436 left to split. If the user does not want to proceed to split the transaction 436, the user can cancel the request by clicking the “Cancel” button. In some examples, pressing the “Cancel” button can redirect the user to the main menu. In other examples, pressing the “Cancel” button can redirect the user to the previous page. The user can navigate to the main menu of the transaction account management user interface by clicking the “Main Menu” button. The user can terminate the session by clicking the “Log out” button. In some instances, clicking the “Log out” button will redirect the user to the user interface of FIG. 2A.

Referring next to FIG. 2D, the user is presented with a user interface that shows the transactions 436 after successfully splitting the eligible transaction. In some examples, the user interface can display the list of transactions 436 and an updated transaction amount for the split transaction. The updated transaction amount is an amount that is not split. In some embodiments, the transaction status can change to “adjusted” or similar terms to indicate the transaction has been split. In some embodiments, the user interface 466 can include a message or a notification to notify the user of the status of the split. In this example, the user can terminate the session by clicking the “Log out” button. The user can split another eligible transaction by clicking “split” on the transaction 436. The user can navigate to the main menu of the transaction account management user interface by clicking the “Main Menu” button.

Referring next to FIG. 2E, the user selected the eligible transaction to be split. The user interface 466 can display one or more of the transaction accounts 433 assigned to the user. In some examples, the user can split the transaction 436 between the plurality of transaction accounts 433 assigned to the user. In some embodiments, the user interface 466 can include the global purchasing capacity 443 of the user. In some examples, the global purchasing capacity 443 can be calculated to include the respective purchasing power 439 of the transaction accounts 433 associated with the user. The user interface 466 further includes an input box for the user to input a percentage of the amount 483 to split. The amount 483 of the transaction 436 can be reflected on the user interface 466. For example, if the user selected the “business warehouse” transaction with the amount 483 of $10,378.91,” the user interface 466 can reflect the “50%” of the amount 483 to be split with a message such as “$8,689.46 of $17,378.91.” In some embodiments, the user interface 466 can display the amount 483 of the transaction 436 left to split. If the user does not want to proceed to split the transaction 436, the user can cancel the request by clicking the “Cancel” button. In some examples, pressing the “Cancel” button can redirect the user to the main menu. In other examples, pressing the “Cancel” button can redirect the user to the previous page. The user can navigate to the main menu of the transaction account management user interface by clicking the “Main Menu” button. The user can terminate the session by clicking the “Log out” button. In some instances, clicking the “Log out” button will redirect the user to the user interface of FIG. 2A.

Referring next to FIG. 2F, the user is presented with a user interface of the transactions 436 after successfully splitting the eligible transaction. In some examples, the user interface 466 can display the list of transactions 436 and an updated transaction amount for the split transaction. The updated transaction amount is an amount that is not split. In some embodiments, the transaction status can change to “adjusted” or similar terms to indicate the transaction has been split. In some embodiments, the user interface 466 can include a message or a notification to notify the user of the status of the split. In this example, the user can terminate the session by clicking the “Log out” button. The user can split another eligible transaction by clicking “split” on the transaction 436. The user can navigate to the main menu of the transaction account management user interface by clicking the “Main Menu” button.

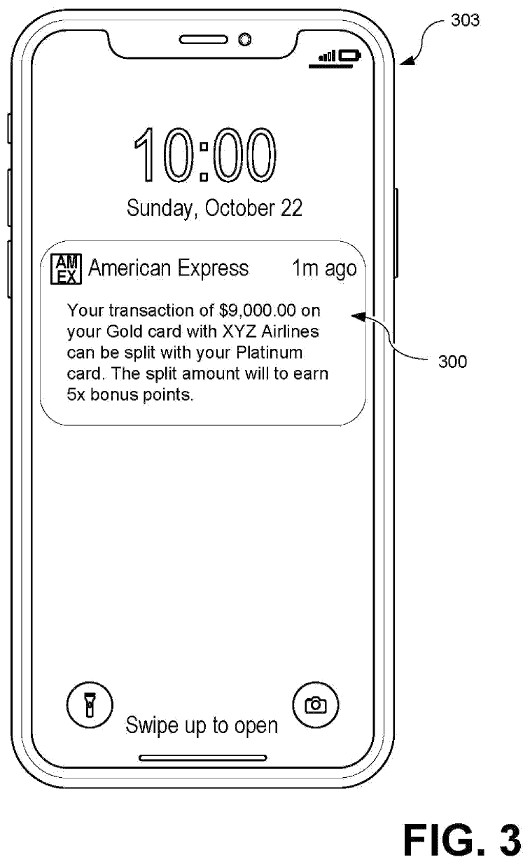

FIG. 3 depicts a client device 303, presenting the user with a notification 300 on the display 469 of the client device 303. In some examples, the notification could provide the user with a transaction-split offer. In other examples, the notification 300 could remind the user of the transaction-split offer. If the user selects or interacts with the notification 300, then the user could proceed to the user interface similar to the user interface depicted in FIGS. 2A-2F.

In another example, such as the example depicted in FIG. 3, the client device 406 of the user could receive a notification 300 after the transaction 436 (FIG. 4) has been completed, that the transaction is eligible for a transaction-split offer. If a user completes a transaction with a qualifier (e.g., an eligible merchant, an amount, a transaction type, etc.), the user could receive a notification 300 on his or her client device 303 informing the user that the transaction is eligible for a transaction-split offer. If the user selects or interacts with the notification 300, then the user could proceed to the user interface similar to the user interface depicted in FIG. 2B.

As illustrated in FIG. 4, shown is a network environment 400 according to various embodiments. The network environment 400 can include a computing environment 403 and a client device 406, which can be in data communication with each other via a network 409.

The network 409 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 409 can also include a combination of two or more networks 409. Examples of networks 409 can include the Internet, intranets, extranets, virtual private networks (VPNs), and similar networks.

The computing environment 403 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 403 can employ a plurality of computing devices that can be arranged in one or more server banks or computer banks or other arrangements. Such computing devices can be located in a single installation or can be distributed among many different geographical locations. For example, the computing environment 403 can include a plurality of computing devices that together can include a hosted computing resource, a grid computing resource, or any other distributed computing arrangement. In some cases, the computing environment 403 can correspond to an elastic computing resource where the allotted capacity of processing, network, storage, or other computing-related resources can vary over time.

Various applications or other functionality can be executed in the computing environment 403. The components executed on the computing environment 403 include a transaction account enhancement application 413 and other applications, services, processes, systems, engines, or functionality not discussed in detail herein. Moreover, the transaction account enhancement application 413 can contain component applications such as a transaction splitting service 416 and a purchasing power reallocation service 419 which can be executed by the computing environment 403.

Also, various data is stored in a data store 423 that is accessible to the computing environment 403. The data store 423 can be representative of a plurality of data stores 423, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 423 is associated with the operation of the various applications or functional entities described below. This data can include one or more user accounts 426, one or more transaction accounts 433, one or more transaction records 435, a global purchasing capacity 443, one or more splitting rules 446, one or more reallocation rules 449, a risk profile 453, a risk exposure 456, and potentially other data.

Individual transaction accounts 433 can represent various payment accounts that can be used to make a payment from one party to another, such as from a customer or consumer to a merchant. Examples of transaction accounts 433 can include credit card accounts, charge card accounts, debit card accounts, checking accounts, money market accounts, or other demand deposit, stored value, or credit accounts. Accordingly, each transaction account 433 can include a transaction account identifier 459 that uniquely identifies the transaction account 433 with respect to other transaction accounts 433. Examples of transaction account identifiers 459 include personal account numbers such as credit card numbers, debit card numbers, charge card numbers, demand deposit account (DDA) numbers (e.g., for checking, savings, and similar accounts), as well as tokenized versions of the same. In some examples, the transaction account 433 could be qualified as an eligible transaction account 433 by having a higher purchasing power than the first transaction account. In other examples, the transaction account 433 could be qualified as the eligible transaction account 433 by including an available purchasing power 439 greater than an eligible transaction.

Individual user accounts 426 can represent information related to individual users or customers of a transaction account issuer. For example, a customer of a bank might have one user account representing the user and his or her relationship with the bank. Accordingly, a user account 426 can include a user identifier 429 that uniquely identifies a user account 426 with respect to another user account 426. A user account 426 can also include one or more transaction account identifiers 459, which serve to identify the transaction accounts 433 the user is authorized to use, either as the owner of the transaction account 433 or as an authorized user of the transaction account 433. In some examples, the user identifier 429 can be a customer ID number, an account number, a username, or an email address. In some implementations, individual users may have multiple transaction accounts 433 associated with their user account 426, such as when a user has separate transaction accounts 433 for work and personal expenses or multiple transaction accounts 433 to maximize rewards programs or other benefits. In some examples, the user identifier 429 could be used to authenticate the user into the user interface 466 to manage the one or more transaction accounts 433.

Individual transaction records 435 can represent information associated with the one or more transactions 436 using a transaction account 433. Transaction records 435 can be created in response to the transaction 436 associated with the transaction account 433. Transaction records 435 can store relevant data such as the transaction account identifier 459 of the transaction account 433 used to fund or pay for the transaction 436, the amount 483 of the transaction, the merchant identifier of the merchant who submitted the transaction for authorization as the merchant of record, a merchant type, a transaction date, a transaction type, a description, and other suitable transaction data elements.

The one or more transactions 436 can represent a recorded exchange between the user and a merchant. In some embodiments, the one or more transactions 436 can represent a deposit, a withdrawal, a transfer, or a purchase. The transaction 436 can be linked to the transaction record 435. In some examples, the one or more transactions 436 could be eligible to be split between the first transaction account 433 and the second transaction account 433. In some instances, the one or more transaction 436 could qualify for a transaction-split offer.

The purchasing power 439 can represent the available balance or amount of money the user can spend based at least in part on a limit of the transaction account 433. The purchasing power 439 is linked to the transaction account 433. In some examples, the user can have a transaction account 433 such as a charge card that does not have a purchasing power or credit limit. The purchasing power 439 can be used to determine if the user can perform the transaction 436 such as a purchase or a withdrawal. Each transaction account 433 associated with the user can have a respective purchasing power 439. The transaction account 433 can have an insufficient purchasing power which could occur when the available purchasing power 439 is lower than the transaction amount 483. The insufficient purchasing power can disallow the user from performing the transaction 436. The respective purchasing power 439 for a first transaction account 433 could be the same or different from the respective purchasing power 439 of a second transaction account 433. In some examples, the respective purchasing power 439 of the second transaction account 433 may be based at least in part on the first transaction account 433. The respective purchasing power 439 could be used to approve or decline financial transactions.

The global purchasing capacity 443 can represent the total of one or more respective purchasing powers 439. The global purchasing capacity 443 can represent the respective purchasing power 439 and available loans that the user is authorized to use across all of the transaction accounts 433 or transaction products with the financial institution. The global purchasing capacity 443 can be modified based at least in part on the risk profile 453. In other examples, the global purchasing capacity 443 can be modified based at least in part on the risk exposure 456. In some other examples, the global purchasing capacity 443 can be modified based at least in part on the respective purchasing power 439. The user can request the global purchasing capacity 443 to be modified. In some examples, the global purchasing capacity 443 could be used to approve or decline financial transactions. In some examples, the global purchasing capacity 443 is recalculated based at least in part on a modification to the purchasing power 439. In other examples, the global purchasing capacity 443 could be recalculated based at least in part on the user opening a new transaction account 433.

The one or more splitting rules 446 can represent the rules for splitting the transactions 436 across the one or more transaction accounts 433. The splitting rules 446 can represent how the financial institution determines eligibility for a transaction to be split. The splitting rules 446 can be used to determine a type of split between the first transaction account 433 and the second transaction account 433, such as a proportional split, a partial split, an exact split, a percent split, or other similar types of splitting methods. In other examples, the one or more splitting rules 446 can determine how the transactions can be split. In some other examples, the one or more splitting rules 446 can determine which one of the transactions 436 can be split across the transaction accounts 433. In some examples, the one or more splitting rules can determine which one of the transactions 436 can be split based at least in part on a category of the transaction 436. The category of the transaction 436 can be at least one or more of a travel category, a dining and entertainment category, a grocery category, a gas and transportation category, an online shopping category, a balance transfer, etc.

The billing cycle can be a recurring time period where a financial institution issues a credit statement, bill, or invoice. In some examples, the billing cycle can be used to track transactions. In some instances, the billing cycle can be a monthly billing cycle, a bi-monthly billing cycle, a quarterly billing cycle, a semi-annual billing cycle, or a variable billing cycle. In some examples, the variable billing cycle can be specified and/or defined by a user. In some examples, the one or splitting rules 446 can determine which one of the transactions can be split across the transaction accounts 433 based at least in part on a billing cycle.

The set of reallocation rules 449 can represent the rules for requesting a modification to the respective purchasing power 439 of the transaction account 433. In some embodiments, the set of reallocation rules 449 could represent the rules for requesting a modification to the global purchasing capacity 443. In some instances, the reallocation rules 149 can reallocate purchasing power from the first transaction account 433 to the second transaction account 433. In other examples, the reallocation rules 149 can reallocate purchasing power 139 from the first transaction account 433 to the second transaction account 433 without a credit inquiry.

The risk profile 453 can represent factors associated with the user based at least in part on the user's credit history, a plurality of credit factors, financial information, and demographic information. The financial information can be factors such as incomes, expenses, assets, and liabilities. The credit history can be factors such as the user's on-time payment history and past behavior on credit accounts.

The plurality of credit factors can comprise a user's global purchasing capacity utilization, length of credit history, recent credit inquiries, and types of credit. The types of credit can include credit card accounts, loans, mortgages, etc. The demographic information can be factors such as the user's age, gender, education level, and occupation. The user's behavioral information can be factors such as typical spending habits, transaction types, and financial transaction account utilization. In some examples, the risk profile 453 can be fetched or retrieved from the data store. The risk profile 453 can be based at least in part on the input provided by the user during registration or enrollment. In some examples, the risk profile 453 can be based at least in part on an input from the user.

The risk exposure 456 can represent factors associated with the user that could incur potential financial losses to the financial institution. In some examples, the risk exposure 456 can include factors such as the user's credit utilization, loan-to-value ratio, debt-to-income ratio, and financial stability/obligations. The user's credit utilization is based at least in part on the global purchasing capacity 443 and/or the purchasing power 439 of the user. In some examples, the risk exposure 156 can be determined or calculated based at least in part on the risk profile 453 and/or the global purchasing capacity 443. In other examples, the risk exposure 456 can be determined or calculated based at least in part on the input provided by the user.

The transaction account enhancement application 413 can be executed to modify at least one of the purchasing power 439, the global purchasing capacity 443, or the one or more transactions 436. The transaction account enhancement application 413 can create a transaction record 435 recording the transaction and save the transaction record 435 to the data store 423. In some embodiments, the transaction account enhancement application 413 can be executed to modify or configure the one or more transaction account 433.

The client device 406 is representative of a plurality of client devices that can be coupled to the network 409. The client device 406 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 406 can include one or more displays 169, such as liquid crystal displays (LCDs), gas plasma-based flat panel displays, organic light emitting diode (OLED) displays, electrophoretic ink (“E-ink”) displays, projectors, or other types of display devices. In some instances, the display 469 can be a component of the client device 406 or can be connected to the client device 406 through a wired or wireless connection. In some instances, the client device 406 can include one or more sensors 479, such as a location detection unit, an accelerometer, a gyroscope, a camera, fingerprint sensor, iris sensor, and other suitable sensors.

The sensor 479 can be used for determining which transaction accounts 433 are available for display on the client device 406 based on the location of the client device 406. Additionally, in some examples, the sensor 479 can be used for determining the dynamically determining layout of the user interfaces rendered on the display 469. For instances, text and/or graphics relocated based at least in part on a detected orientation (e.g., portrait or landscape) of the display 469 on the client device 406. The text and graphics can be dynamically relocated based on detected gestures (via a touchscreen display) on the display 469. The text and graphics can be dynamically relocated in order to create viewable area in the display 469 for other related text and/or graphics. In some examples, the sensors 479 could be used to capture a biometric marker of the user.

Various data is stored in a client data store 473 that is accessible to the client device 406. The data stored in the client data store 473 is associated with the operation of the various applications or functional entities described below. This data can include credentials 476, the transaction account 433, and potentially other data.

The credentials 476 can include data for authenticating the client device 406 with the computing environment 403. Some examples of credentials 476 can include password, tokens, session key, and other suitable credential data.

The client device 406 can be configured to execute various applications such as a client application 463 or other applications. The client application 463 can be executed in a client device 406 to access network content served up by the computing environment 403 or other servers, thereby rendering a user interface 466 on the display 469. To this end, the client application 463 can include a browser, a dedicated application, or other executable, and the user interface 466 can include a network page, an application screen, or other user mechanism for obtaining user input. The client device 406 can be configured to execute applications beyond the client application 463 such as email applications, social networking applications, word processors, spreadsheets, or other applications.

Additionally, the client device 406 can be configured to execute various applications such as a client application 463 or other applications. The client application 463 can be executed to interface with the transaction account enhancement application 413, the transaction splitting service 416, or the purchasing power reallocation service 419. The client application 463 can be used to display user interfaces for the transaction account enhancement application 413 and provide data to the transaction splitting service 416 or purchasing power reallocation service 419 related to the enhancement of financial transaction capabilities for the one or more transaction accounts 433.

Next, a general description of the operation of the various components of the network environment 400 is provided. Although the following description provides a general description of the interactions between the various components of the network environment 400, other interactions are also encompassed by the various embodiments of the present disclosure.

To begin, a financial institution can offer financial transaction accounts 433 among other services to users, clients, businesses, etc. Often times, users/clients will have multiple financial transaction accounts 433 at the financial institution. The financial institution could use the risk exposure 456 and/or the risk profile 453 of the user/client to assign the respective purchasing power 439 to the transaction account 433. However, the user/client can only make purchases on the financial account to the maximum limit of the respective purchasing power 439 of the transaction account 433. In order to make a purchase in excess of the purchasing power 439, the user/client could have to pay off at least a portion of the account or request an increase of the purchasing power 439. To allow the user/client to continue using the financial transaction account(s) 433 at the financial institution, the transactions 436 can be split and/or the purchasing power 439 can be increased based at least in part on the global purchasing capacity 443.

To allow the user to continue to use the transaction account 433, the user can request to split the eligible transaction or modify the purchasing limit of the transaction account. First, the user can login via the user interface 466 on the client device 406. The user will be authenticated by the user identifier 429 of the user account 426. The user can select the transaction account 433 to request the split and/or the purchasing power 439 modification.

Upon selecting the option to modify the purchasing power 439, the purchasing power reallocation service 419 can identify the respective purchasing power 439 for the transaction accounts 433 associated with the user account 426. The purchasing power could be used to calculate the global purchasing capacity 443. The user can input a specific amount for the purchasing power modification or select an option to increase. The purchasing power 439 can be reallocated from another transaction account 433 to the requested transaction account 433 based at least in part on one of the global purchasing capacity 443, the reallocation rules 449, risk profile 453, or the risk exposure 456.

Upon selection of the option to split the transaction 436, the transaction splitting service 416 of the transaction account enhancement application 413 will fetch the transactions 436 based at least in part on the transaction account 433. The transaction splitting service 416 can determine transaction split eligibility based at least in part on the one or more splitting rules 445. The transaction splitting service 416 could request input from the user to select the eligible transaction to split. The transaction splitting service 416 can request another input for selecting the transaction account 433 to split the transaction with. Once the transaction 436 is split, the respective purchasing power 439 of the transaction accounts 433 can be updated. The transaction splitting service 416 can display an indication the transaction 436 is split.

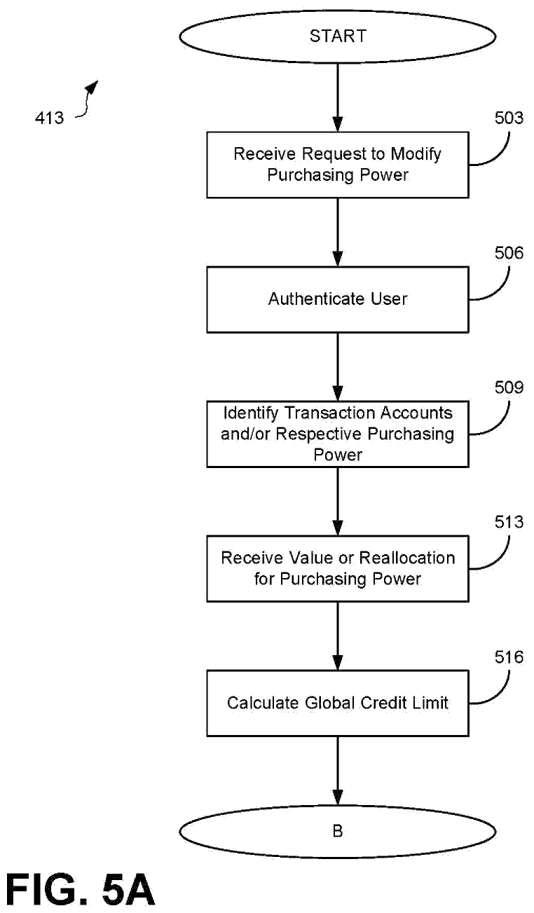

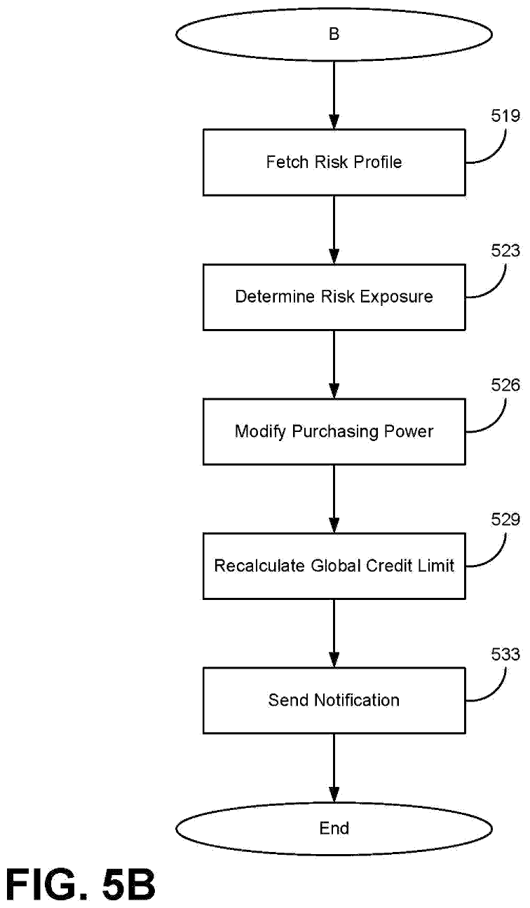

Referring next to FIGS. 5A and 5B, shown is a flowchart that provides one example of the operation of a portion of the transaction account enhancement application 413. The flowchart of FIGS. 5A and 5B provides merely an example of the many different types of functional arrangements that can be employed to implement the operation of the depicted portion of the transaction account enhancement application 413. As an alternative, the flowchart of FIGS. 5A and 5B can be viewed as depicting an example of elements of a method implemented within the network environment 400.

Beginning with block 503, the purchasing power reallocation service 419 of the transaction account enhancement application 413 can receive a request to modify the purchasing power 439 of the one or more transaction accounts 433.

At block 506, the purchasing power reallocation service 419 of the transaction account enhancement application 413 can receive a request to login and authenticate the user. The user can submit the credentials 476 to a login user interface displayed on the client device 406. In some instances, the client application 463 can transmit the submitted credentials 476 to the transaction account enhancement application 413. The transaction account enhancement application 413 can authenticate the user with the user identifier 429 with the computing environment 403. In some other examples, the user can be identified and authenticated based at least in part on the user account 426 and/or the user identifier 429.

At block 509, the purchasing power reallocation service 419 of the transaction account enhancement application 413 can identify the transaction accounts 433 associated with the user. In some instances, the purchasing power reallocation service 419 can identify the transaction accounts 433 associated with the user based at least in part on the transaction account identifier 459 associated with the user account 426. The transaction account selection user interface can display transaction accounts 433 associated with the user. In some examples, the transaction account selection user interface can be displayed on the client device 406. In some embodiments, the transaction account selection user interface can display an image of the transaction account 433 or list the type of transaction account 433 based at least in part on the transaction account identifier 459. In some other examples, the transaction account 433 can be selected by way of an image of the transaction account 433 or a user interface element associated with each transaction account 433. In some examples, the transaction accounts 433 that are displayed on the transaction account selection user interface can be determined based at least in part on one or more factors. For instance, the location of the client device 406 can be used to identify which transaction accounts 433 are available to the user. The location can be determined by a sensor 479 (e.g., a GPS device), from stored location data in the user account 426, and other suitable data.

In some other embodiments, the purchasing power reallocation service 419 of the transaction account enhancement application 413 can identify the respective purchasing power 439 of the transaction account 433. In some examples, the respective purchasing power 439 could be identified for the transaction account 433 selected by the user on the transaction account selection user interface. In some other examples, the purchasing power 439 can be identified for all the transaction accounts 433 associated to the user. In some embodiments, the purchasing power 439 can be modified to be increased or decreased. In some other embodiments, the purchasing power 439 of the transaction account 433 can be modified prior to splitting the transaction 436. In other examples, the purchasing power 439 can be modified based at least in part on the request from the user.

At block 513, the purchasing power reallocation service 419 of the transaction account enhancement application 413 can receive an input (e.g., a value, a percentage, etc.) for the modification of the purchasing power 439 of the transaction account 433. In some embodiments, the input can include a selection of the one or more transaction account 433 for the reallocation of the purchasing power 439. In some examples, the purchasing power 439 could be limited to the global purchasing capacity 443. In some examples, the purchasing power reallocation service 419 can display a purchasing power reallocation user interface on the display 469 of the client device 406. The purchasing power reallocation user interface can display an image of the transaction accounts 433 with the respective purchasing power 439 of the transaction accounts 433. The user can specify the reallocation of the purchasing power 439 by inputting a specific amount to reallocate from the first transaction account 433 to the second transaction account 433. In some other examples, the user can request an automatic reallocation of the purchasing power 439 based at least in part on one or more of the global purchasing capacity 443, the risk profile 453, and/or the risk exposure 456.

At block 516, the purchasing power reallocation service 419 of the transaction account enhancement application 413 can calculate the global purchasing capacity 443 of the user based at least in part on the respective purchasing power 439 of the transaction accounts 433. In some examples, the global purchasing capacity 443 can be a calculation of the respective purchasing power 439 of one type of transaction account 433. In some other examples, the global purchasing capacity 443 can be displayed on the user interface 466 of the client device 406. In other examples, the global purchasing capacity 443 can be used to approve or decline transactions.

At block 519, the purchasing power reallocation service 419 of the transaction account enhancement application 413 can fetch the risk profile 453 of the user to facilitate the request to modify the respective purchasing power 439. The risk profile 453 and the risk exposure 456 can be used to assess the request to allocate the purchasing power 439.

At block 523, the purchasing power reallocation service 419 of the transaction account enhancement application 413 can determine the risk exposure 456 of the request to modify the purchasing power 439. In some examples, the financial institution can apply rules and policies to assess the request to reallocate the purchasing power 439. In other examples, the risk exposure 456 can be calculated based at least in part on the risk profile 453, user account 426, and/or the transaction records 435.

At block 526, the purchasing power reallocation service 419 of the transaction account enhancement application 413 can modify the respective purchasing power 439 of the transaction account 433. In some embodiments, the purchasing power 439 can be modified based at least in part on an input from the user. In some examples, the respective purchasing power 439 can be updated based at least in part on the risk exposure 456. In other examples, the respective purchasing power 439 can be updated based at least in part on the global purchasing capacity 443. In some other examples, the respective purchasing power 439 can be updated in real-time to allow the user to use the modified purchasing power 439 of the transaction account 433. In other examples, the respective purchasing power 439 can be updated after a period of time.

At block 529, the purchasing power reallocation service 419 of the transaction account enhancement application 413 can recalculate the global purchasing capacity 443 based at least in part on the updated purchasing power 439. In some examples, the global purchasing capacity 443 can be a calculation of the respective purchasing power 439 of one type of transaction account 433. In other examples, the global purchasing capacity 443 can be recalculated after each reallocation of the purchasing power 439. In other examples, the global purchasing capacity 443 can be used to approve or decline transactions.

At block 533, the purchasing power reallocation service 419 of the transaction account enhancement application 413 can send a notification to the client device or the client application to notify the user of the updated purchasing power 439. In some embodiments, the purchasing power reallocation service 419 can notify the user of the updated global purchasing capacity 443. In some other examples, the notification can display the modified global purchasing capacity 443. In some examples, the notification can display the respective purchasing power 439 of the transaction account 433. In some examples, the notification can be displayed on the display 469 of the client device 406. In other examples, the notification can be displayed on the user interface 466 of the client device 406. In some examples, the notification can be a summary of the reallocation request.

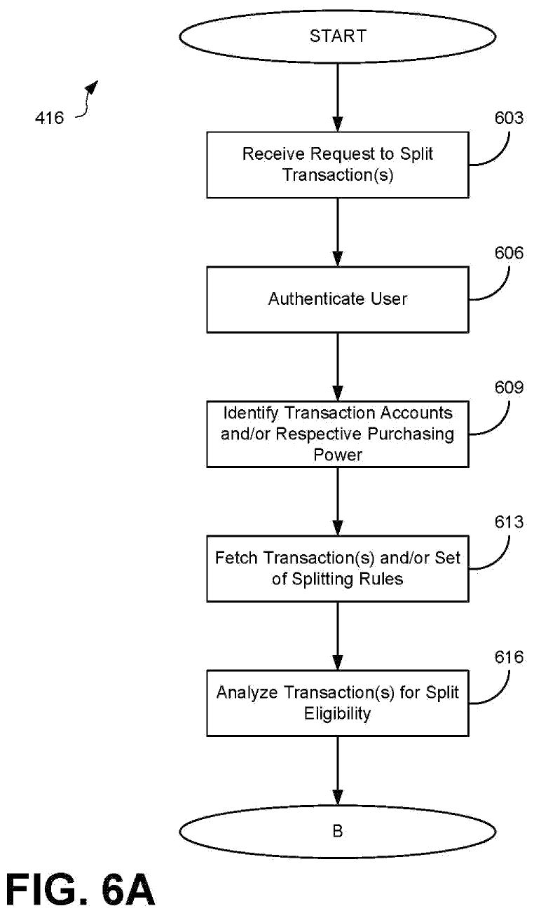

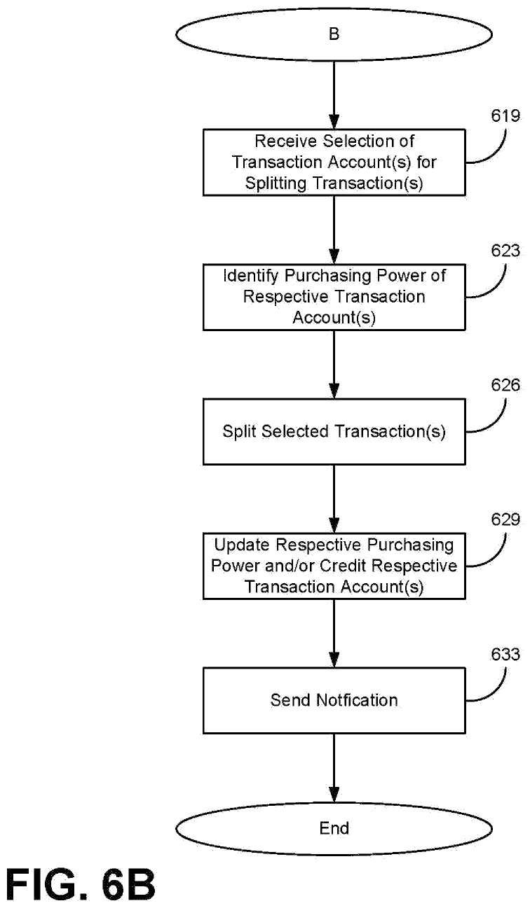

Referring next to FIGS. 6A and 6B, shown is a flowchart that provides one example of the operation of a portion of the transaction account enhancement application 413. The flowchart of FIGS. 6A and 6B provides merely an example of the many different types of functional arrangements that can be employed to implement the operation of the depicted portion of the transaction account enhancement application 413. As an alternative, the flowchart of FIGS. 6A and 6B can be viewed as depicting an example of elements of a method implemented within the network environment 400.

Beginning with block 603, the transaction splitting service 416 of the transaction account enhancement application 413 can receive a request to split the one or more transactions 436. The request could further include information indicating the transaction account 433 to split the one or more transactions 436.

At block 606, the transaction splitting service 416 of the transaction account enhancement application 413 can receive a request to login and authenticate the user. The user can submit the credentials 476 to a login user interface displayed on the client device 406. In some instances, the client application 463 can transmit the submitted credentials 476 to the transaction account enhancement application 413. The transaction account enhancement application 413 can authenticate the user with the user identifier 429 with the computing environment 403. In some other examples, the user can be identified and authenticated based at least in part on the user account 426 and/or the user identifier 429.

At block 609, the transaction splitting service 416 can identify transaction accounts 433 associated with the user and display the transaction account selection user interface for selecting the one or more transaction accounts 433. The transaction account selection user interface can be displayed on the client device 406. In some embodiments, the transaction account selection user interface can display an image of the transaction account 433 based at least in part on the transaction account identifier 459 or the type of transaction account. In some other examples, the transaction account 433 can be selected by way of an image of the transaction account 433 or a user interface element associated with each transaction account 433. In some examples, the transaction accounts 433 that are displayed on the transaction account selection user interface can be determined based at least in part on one or more factors. For instance, the location of the client device 406 can be used to identify which transaction accounts 433 are available to the user. The location can be determined by a sensor 479 (e.g., a GPS device), from stored location data in the user account 426, and other suitable data.

In some embodiments, the transaction splitting service 416 of the transaction account enhancement application 413 can identify the respective purchasing power 439 of the transaction account 433. In some examples, the respective purchasing power 439 could be identified for transaction account 433 selected by the user on the transaction account selection user interface. In some other examples, the purchasing power 439 can be identified for all the transaction accounts 433 associated to the user. In some embodiments, the purchasing power 439 can be modified to be increased or decreased. In some other embodiments, the purchasing power 439 of the transaction account 433 can be modified prior to splitting the transaction 436. In other examples, the purchasing power 439 can be modified based at least in part on the request from the user.

At block 613, the transaction splitting service 416 of the transaction account enhancement application 413 can fetch the transactions 436 of the individual ones of the transaction accounts 433 associated with the user account 426. The fetched transaction could be displayed on the user interface 466 in a list. In some instances, the fetched transaction could be stored in the data store 423. In some embodiments, the transaction splitting service can also fetch the transaction records 435 associated with the transaction 436. In some examples, the transaction records 435 can include at least one or more of the transaction date, the transaction status, the merchant name, the transaction description, the amount 483, the reward status, or other suitable transaction data elements. In other examples, the one or more transactions 436 can be displayed on the user interface 466 on the display 469 of the client device 406.

In some embodiments, the transaction splitting service 416 of the transaction account enhancement application 413 can identify the one or more splitting rules 446. In some instances, the transaction account enhancement application 413 can fetch the one or more splitting rules 446 from the data store 423. In other examples, the one or more splitting rules 446 can be fetched from the user account 426.

At block 616, the transaction splitting service 416 of the transaction account enhancement application 413 can analyze the one or more transaction 436 to determine the transaction split eligibility. In some examples, the transaction split eligibility can be based at least in part on the one or more splitting rules 446. In some other examples, the transaction splitting service 416 can determine the transaction split eligibility based at least in part on one or more of the transaction date, the transaction status, the merchant name, the transaction description, the amount 483, or the reward status. In some examples, the transaction split eligibility can be based at least in part on the global purchasing capacity 443, the risk profile 453, and/or the risk exposure 456.

At block 619, the transaction splitting service 416 of the transaction account enhancement application 413 can receive a selection of at least one transaction account 433 to split the eligible transaction associated with the first transaction account 433. In some instances, the selection can include a plurality of transaction accounts 433 for splitting the transaction 436 associated with the first transaction account 433. The transaction splitting user interface can display a list of eligible transaction associated with the first transaction account 433. The user can specify the eligible transaction to split between at least the first transaction account 433 and the second transaction account 433. In some other examples, the user can request an automatic split of the eligible transaction between all the transaction accounts 433 associated with the user account 426. In some examples, the user could be prompted for an input to split the eligible transaction between the first transaction account 433 and the second transaction account 433. In some examples, the user can opt to split the eligible transaction between a plurality of transaction accounts 433. In some examples, the user can select to split the eligible transaction based at least in part on a criterion, an amount, or a reward. In other examples, the transaction splitting service 416 can display the transaction splitting user interface to allow the user to split the amount 483 of the transaction 436 using a slider or scale.

At block 623, the transaction splitting service 416 of the transaction account enhancement application 413 can identify the respective purchasing power 439 of the transaction account 433. In some examples, the respective purchasing power 439 could be identified for transaction account 433 selected for the split by the user. In some other examples, the purchasing power 439 can be identified for all the transaction accounts 433 associated to the user. In some other embodiments, the purchasing power 439 of the transaction account 433 can be modified prior to splitting the transaction 436. In other examples, the purchasing power 439 can be modified based at least in part on the request from the user.

At block 626, the transaction splitting service 416 of the transaction account enhancement application 413 can perform a split of the eligible transaction between the first transaction account 433 and the second transaction account 433. In some examples, the transaction splitting service 416 can perform the split of the eligible transaction between a plurality of transaction accounts 433. In other embodiments, the transaction 436 can be split based at least in part on an input from the user, the input comprising a selection of the one or more transaction accounts 433 for the split.

At block 629, the transaction splitting service 416 of the transaction account enhancement application 413 can update the purchasing power 439 of the transaction account 433. In other examples, the respective purchasing power 439 can be updated based at least in part on the global purchasing capacity 443. In some other examples, the respective purchasing power 439 can be updated in real-time. In other examples, the respective purchasing power 439 can be updated after a period of time. In some instances, the transaction splitting service 416 can credit the transaction account 433 of the split amount.

At block 633, the transaction splitting service 416 of the transaction account enhancement application 413 can send a notification to the client device or the client application to notify the user of successfully splitting the transaction 436. In some embodiments, the transaction splitting service 416 can notify the user of the respective purchasing power 439 of the first transaction account 433 and the second transaction account 433. In some other examples, the notification can include the purchasing power 439 of the one or more transaction accounts 433 involved in the split of the transaction 436. In some examples, the notification can be displayed on the display 469 of the client device 406. In other examples, the notification can be displayed on the user interface 466 of the client device 406. In some examples, the notification can be a summary of the transaction split request.

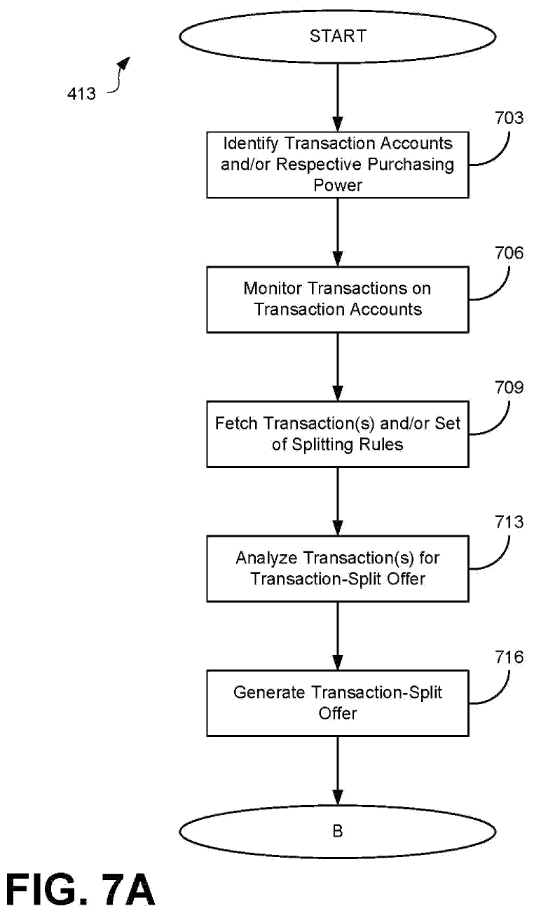

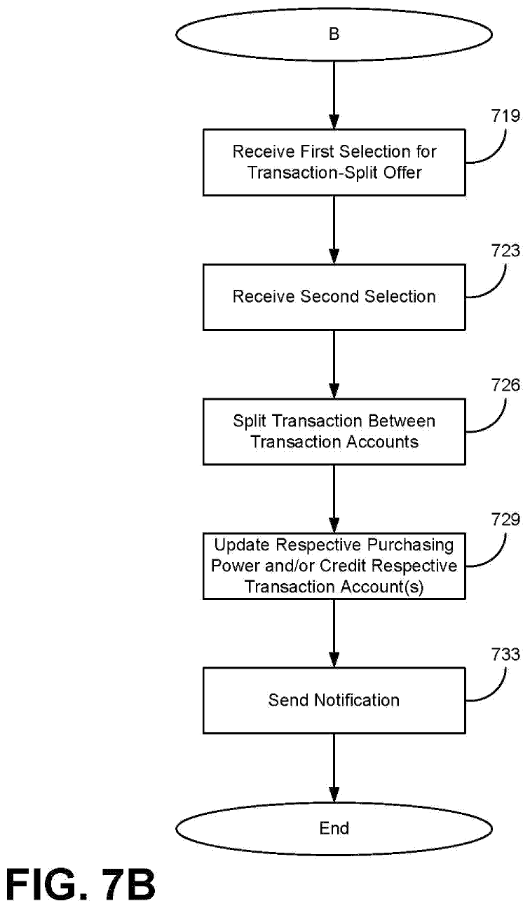

Referring next to FIGS. 7A and 7B, shown is a flowchart that provides one example of the operation of a portion of the transaction account enhancement application 413. The flowchart of FIGS. 7A and 7B provides merely an example of the many different types of functional arrangements that can be employed to implement the operation of the depicted portion of the transaction account enhancement application 413. As an alternative, the flowchart of FIGS. 7A and 7B can be viewed as depicting an example of elements of a method implemented within the network environment 400.

Beginning with block 703, the transaction account enhancement application 413 can identify the transaction accounts 433 associated with the user. In some instances, the purchasing power reallocation service 419 can identify the transaction accounts 433 associated with the user account 426 based at least in part on the transaction account identifier 459. For instance, the location of the client device 406 can be used to identify which transaction accounts 433 are identified for the transaction-split offer. The location can be determined by a sensor 479 (e.g., a GPS device), from stored location data in the user account 426, and other suitable data. In some instances, the transaction account enhancement application 413 can identify the respective purchasing power 439 of the transaction account 433 associated with the user account 426. In some other examples, the purchasing power 439 can be identified for all the transaction accounts 433 associated to the user. In some other embodiments, the purchasing power reallocation service 419 of the transaction account enhancement application 413 can identify the respective purchasing power 439 of the transaction account 433. In some other examples, the purchasing power 439 can be identified for all the transaction accounts 433 associated to the user.

At block 706, the transaction account enhancement application 413 can monitor transactions 436 on the one or more transaction accounts 433 identified for the transaction-split offer. Monitoring the one or more transaction 436 could include reviewing current or past transaction 436 associated with the one or more transaction accounts 433. In some instances, the transactions can be monitored for the type of transaction, a transaction account benefit for the type of transaction, the amount 483, the reward status, the merchant name, and/or the transaction description.

At block 709, the transaction account enhancement application 413 can fetch the transactions 436 of the individual ones of the transaction accounts 433 associated with the user account 426. The fetched transaction could be displayed on the user interface 466 in a list. In some instances, the fetched transaction could be stored in the data store 423. In some embodiments, the transaction splitting service can also fetch the transaction records 435 associated with the transaction 436. In some examples, the transaction records 435 can include at least one or more of the transaction date, the transaction status, the merchant name, the transaction description, the amount 483, the reward status, or other suitable transaction data elements. In other examples, the one or more transactions 436 can be displayed on the user interface 466 on the display 469 of the client device 406.

In some embodiments, the transaction account enhancement application 413 can identify the one or more splitting rules 446. In some instances, the transaction account enhancement application 413 can fetch the one or more splitting rules 446 from the data store 423. In other examples, the one or more splitting rules 446 can be fetched from the user account 426.

At block 713, the transaction account enhancement application 413 can analyze the one or more transaction 436 for the transaction-split offer. In some examples, the transaction-split offer can be based at least in part on the one or more splitting rules 446. In some other examples, the transaction account enhancement application 413 can analyze the transaction for the transactions-split offer based at least in part on one or more of the transaction date, the transaction status, the merchant name, the transaction description, the amount 483, or the reward status. In some examples, the transaction-split offer can be based at least in part on the global purchasing capacity 443, the risk profile 453, and/or the risk exposure 456.

At block 716, the transaction account enhancement application 413 can generate the transaction-split offer for one or more eligible transactions. The transaction-split offer presents the user with an offer to split a transaction to maximize the award or benefit of the transaction account 433 associated with the user account 426. In some examples, generating the transaction-split offer could include notifying the client device 406 of the user. In other instances, generating the transaction-split offer could include marking the one or more eligible transactions with an indicator when presented to the user.

At block 719, the transaction account enhancement application 413 can receive a first selection for the transaction-split offer. The first selection can identify the one or more eligible transactions to split. In some examples, the first selection can further identify the first transaction account based at least in part on the transaction record 435 of the eligible transaction to split.

At block 723, the transaction account enhancement application 413 can receive a second selection based at least in part on the transaction-split offer. The second selection can identify the second transaction account 433 for splitting the one or more eligible transactions. In some instances, the second selection can identify the plurality of transaction accounts 433 for splitting the one or more eligible transactions.

At block 726, the transaction account enhancement application 413 can perform a split of the eligible transaction between the first transaction account 433 and the second transaction account 433. In some examples, the transaction splitting service 416 can perform the split of the eligible transaction between a plurality of transaction accounts 433. In other embodiments, the transaction 436 can be split based at least in part on an input from the user, the input comprising a selection of the one or more transaction accounts 433 for the split.

At block 729, the transaction account enhancement application 413 can update the purchasing power 439 of the transaction account 433. In other examples, the respective purchasing power 439 can be updated based at least in part on splitting the transaction 436 of the transaction-split offer. In some other examples, the respective purchasing power 439 can be updated in real-time. In other examples, the respective purchasing power 439 can be updated after a period of time. In some instances, the transaction splitting service 416 can credit the transaction account 433 of the split amount.

At block 733, the transaction account enhancement application 413 can send a notification to the client device or the client application to notify the user of successfully splitting the transaction 436 based at least in part on the transaction-split offer. In some embodiments, the transaction account enhancement application 413 can notify the user of the respective purchasing power 439 of the first transaction account 433 and the second transaction account 433 selected for the transaction-split offer. In some other examples, the notification can include the purchasing power 439 of the one or more transaction accounts 433 involved in the transaction-split offer. In some examples, the notification can be displayed on the display 469 of the client device 406. In other examples, the notification can be displayed on the user interface 466 of the client device 406. In some examples, the notification can be a summary of the transaction split request.

In some implementations, individual transaction records 435 can indicate that the transaction 436 has been previously split. In these implementations, a previously modified transaction could be presented with an indicator. Examples of different approaches for indicating that a transaction has been previously modified are depicted in FIGS. 2B, 2D, and 2F.

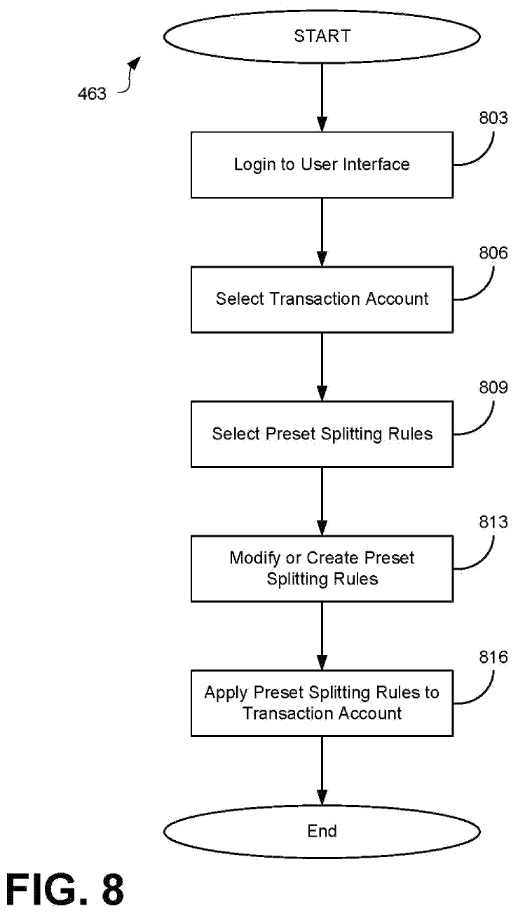

Referring next to FIG. 8, shown is a flowchart that provides one example of the operation of a portion of the client application 463. The flowchart of FIG. 8 provides merely an example of the many different types of functional arrangements that can be employed to implement the operation of the depicted portion of the client application 463. As an alternative, the flowchart of FIG. 8 can be viewed as depicting an example of elements of a method implemented within the network environment 400.

Beginning with block 803, the client application 463 can display a login user interface on the display 469 of the client device 406. The login user interface provides affordances for the user to input credentials, (e.g., username and password, physical security key, etc.) to login to the account management user interface. In some examples, the user can login to select one or more preset splitting rules. In some other examples, the user can login to split the eligible transaction. The user interface 466 of the client device 406 can be used to input the requested username and password. In some instances, an input device can be used to input the requested username and password.

At block 806, the client application 463 can display the transaction accounts 433 assigned to the user and display the transaction account selection user interface for the user to select the transaction account 433. The transaction account selection user interface can display transaction accounts 433 assigned to the user. In some other examples, the transaction account selection user interface can display transaction accounts 433 associated with the user. In some embodiments, the transaction account selection user interface can display an image of the transaction account 433 or the type of transaction account. In some other examples, the transaction account 433 can be selected by way of an image of the transaction account 433 or a user interface element associated with each transaction account 433. In some examples, the transaction accounts 433 that are displayed on the transaction account selection user interface can be determined based at least in part on one or more factors. For instance, the location of the client device 406 can be used to identify which transaction accounts 433 are available to the user. The location can be determined by a sensor 479 (e.g., a GPS device), from stored location data in the user account 426, and other suitable data.

At block 809, the client application 463 can display one or more preset splitting rules to be selected by the user. In some examples, the user can select a plurality of preset splitting rules to apply to the transaction account 433. In other examples, the user can select an individual one of the one or more preset splitting rules.

At block 813, the client application 463 can display a rule modification user interface to allow the user to create or modify the one or more preset splitting rules. In some instances, the user can define a new preset splitting rule to automatically split a posted transaction. In other examples, the user can modify the preset splitting rule to automatically split the transaction 436 based at least in part on meeting one or more qualifiers.

At block 816, the client application 463 can apply the one or more preset splitting rules to the transaction account 433. In some instances, transactions 436 can be automatically split based at least in part on the one or more preset splitting rules.

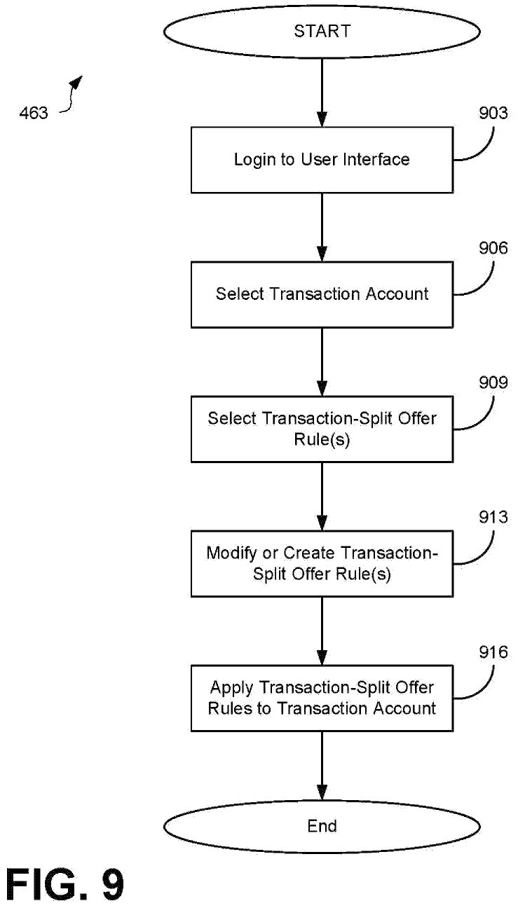

Referring next to FIG. 9, shown is a flowchart that provides one example of the operation of a portion of the client application 463. The flowchart of FIG. 9 provides merely an example of the many different types of functional arrangements that can be employed to implement the operation of the depicted portion of the client application 463. As an alternative, the flowchart of FIG. 9 can be viewed as depicting an example of elements of a method implemented within the network environment 400.

Beginning with block 903, the client application 463 can display a login user interface on the display 469 of the client device 406. The login user interface provides affordances for the user to input credentials 476 (e.g., username and password, physical security key, etc.) to login to the account management user interface. In some examples, the user can login to select one or more preset splitting rules. In some other examples, the user can login to split the eligible transaction. The user interface 466 of the client device 406 can be used to input the requested username and password. In some instances, an input device can be used to input the requested credentials 476 (e.g., username and password, etc.).

At block 906, the client application 463 can display the transaction accounts 433 assigned to the user and display the transaction account selection user interface for the user to select the transaction account 433. The transaction account selection user interface can display transaction accounts 433 assigned to the user. In some other examples, the transaction account selection user interface can display transaction accounts 433 associated with the user. In some embodiments, the transaction account selection user interface can display an image of the transaction account 433 or the type of transaction account. In some other examples, the transaction account 433 can be selected by way of an image of the transaction account 433 or a user interface element associated with each transaction account 433. In some examples, the transaction accounts 433 that are displayed on the transaction account selection user interface can be determined based at least in part on one or more factors. For instance, the location of the client device 406 can be used to identify which transaction accounts 433 are available to the user. The location can be determined by a sensor 479 (e.g., a GPS device), from stored location data in the user account 426, and other suitable data.

At block 909, the client application 463 can display one or more transaction-split offer rules to be selected by the user. In some examples, the user can select a plurality of transaction-split offer rules to apply to the transaction account 433. In some instances, the one or more transaction-split offers can be selected to be applied to the user account 426. In other examples, the user can select an individual one of the one or more transaction-split offer rules to apply to individual ones of the transaction accounts 433.

At block 913, the client application 463 can display the rule modification user interface to allow the user to create or modify the one or more transaction-split offer rules. In some instances, the user can define a new transaction-split offer rule.

At block 916, the client application 463 can apply one or more of the set of preset splitting rules to the transaction account 433. In some instances, the preset splitting rules

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 403.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A method comprising:
calculating a global purchasing capacity for a modification of a respective purchasing power associated with a respective transaction account, the global purchasing capacity based at least in part on the respective purchasing power of one or more transaction accounts;
determining a risk exposure based at least in part on a risk profile and the global purchasing capacity;
modifying the respective purchasing power of respective ones of the one or more transaction accounts;
in response to modifying the respective purchasing power, recalculating the global purchasing capacity; and
sending a notification to a client application, the notification comprising a modified purchasing power of the respective ones of the one or more transaction accounts.

2. The method of claim 1, wherein the modification of the respective purchasing power associated with the respective transaction account further comprises:
a value for the modification of the respective purchasing power; or
a reallocation of the respective purchasing power from a second transaction account to a first transaction account.

3. The method of claim 1, wherein modifying the respective purchasing power is based at least in part on one or more of a max modification, the global purchasing capacity, or the risk exposure.

4. The method of claim 3, wherein determining the risk exposure further comprises:
fetching the risk profile, the risk profile comprising a plurality of credit factors; and
calculating the max modification based at least in part on the risk profile.

5. The method of claim 1, further comprising:
recalculating the respective purchasing power of at least one or more transaction accounts;
sending a first notification, the first notification comprising a confirmation of the modification of the respective purchasing power; and
sending a second notification, the second notification comprising at least one of the global purchasing capacity or the modified purchasing power of a first transaction account.

6. The method of claim 1, further comprising:
performing an authentication process; and
identifying the one or more transaction accounts and the respective purchasing power associated with the respective transaction account.

7. A method comprising:
receiving a request to split a transaction;
receiving a first selection from a client application, the first selection identifying a selected transaction to split;
analyzing the selected transaction to determine a split eligibility, wherein the split eligibility is based at least in part on one or more splitting rules;
receiving a second selection from the client application, the second selection identifying a second transaction account for splitting the selected transaction; and
split the selected transaction between a first transaction account and the second transaction account.

8. The method of claim 7, further comprising:
creating a new transaction on the second transaction account based at least in part on a split of the selected transaction between the first transaction account and the second transaction account;
applying a credit to the first transaction account; and
updating a purchasing power of the first transaction account and the second transaction account.

9. The method of claim 7, further comprising:
identifying a respective purchasing power associated with individual ones of a plurality of transaction accounts; and
identifying a global purchasing capacity based at least in part on the respective purchasing power of respective ones of the plurality of transaction accounts.

10. The method of claim 7, wherein the one or more splitting rules comprises at least one or more of an amount of the selected transaction, a billing cycle of the selected transaction, or a category of the selected transaction.

11. The method of claim 7, further comprising, in response to splitting the selected transaction, recalculating a respective purchasing power associated with a plurality of transaction accounts.

12. The method of claim 7, further comprising in response to determining the split eligibility, determining one or more eligible transaction accounts for splitting the selected transaction based at least in part on one or more of an eligible merchant or a posted transaction.

13. The method of claim 7, wherein the selected transaction can be split in a plurality of splitting methods, the plurality of splitting methods comprising splitting by an exact amount, a percentage, or a preset amount.

14. A system, comprising:
a computing device comprising a processor and a memory; and
machine-readable instructions stored in the memory that, when executed by the processor, cause the computing device to at least:
identify a plurality of transaction accounts;
monitor one or more transactions on the plurality of transaction accounts for a transaction-split offer;
identify, from the one or more transactions, one or more split eligible transactions for the transaction-split offer; and
receive a first selection from a client application, the first selection identifying the one or more split eligible transactions to split.

15. The system of claim 14, wherein the machine-readable instructions, when executed by the processor, further cause the computing device to:
receive a second selection from the client application, the second selection identifying an eligible transaction account for splitting the one or more split eligible transactions, wherein the eligible transaction account comprises an available purchasing power of at least an amount of a split eligible transaction, an eligible transaction amount comprising a total of the one or more split eligible transactions to split; and
split the one or more split eligible transactions between a first transaction account and the eligible transaction account.

16. The system of claim 15, wherein the machine-readable instructions, when executed by the processor, further cause the computing device to:
create a new transaction on the eligible transaction account based at least in part on a split of the one or more split eligible transactions;
apply a credit to the first transaction account; and
update a purchasing power of the first transaction account and the eligible transaction account.

17. The system of claim 15, wherein the machine-readable instructions, when executed by the processor, further cause the computing device to:
identify a global purchasing capacity based at least in part on a respective purchasing power of the plurality of transaction accounts;
receive a second request to modify the respective purchasing power of a respective ineligible transaction account based at least in part on the eligible transaction amount, wherein the respective ineligible transaction account comprises an insufficient purchasing power, the insufficient purchasing power comprising the amount lower than the eligible transaction amount; and
modify the respective purchasing power of the respective ineligible transaction account based at least in part on the global purchasing capacity.

18. The system of claim 17, wherein the machine-readable instructions, when executed by the processor, further cause the computing device to recalculate the respective purchasing power of the plurality of transaction accounts.

19. The system of claim 14, wherein the machine-readable instructions, when executed by the processor, further cause the computing device to determine at least one transaction account benefit for the plurality of transaction accounts, wherein the transaction-split offer is based at least in part on one or more of one or more splitting rules, the at least one transaction account benefit, or a transaction type.

20. The system of claim 19, wherein the one or more splitting rules comprises at least one or more of an amount of the one or more split eligible transactions, a billing cycle of the one or more split eligible transactions, or a category of the one or more split eligible transactions.
